(19) United States
(12) Patent Application Publication
(10) Pub. No.: US 2013/0274484 A1
(43) Pub. Date: Oct. 17, 2013

(54) AROMATIC COMPOUNDS BEARING AT LEAST ONE PHOSPHONATE OR PHOSPHINATE GROUP, PREPARATION METHOD AND USES THEREOF

(71) Applicants: Floryan De Campo, Shanghai (CN); Tao Zhang, Shanghai (CN); Changkai Zhou, Shanghai (CN)

(72) Inventors: Floryan De Campo, Shanghai (CN); Tao Zhang, Shanghai (CN); Changkai Zhou, Shanghai (CN)

(21) Appl. No.: 13/997,631

(22) PCT Filed: Dec. 24, 2010
(86) PCT No.: PCT/CN10/80263

§ 371 Date: Jun. 24, 2013

(51) Int. Cl. C07F 9/38; C07F 9/6553

(52) U.S. Cl. CPC C07F 9/3882; C07F 9/655345
USPC 549/6; 562/23

(57) ABSTRACT

An aromatic compound bearing at least a phosphonate or phosphinate group on the aromatic ring is described. Further described, is the process by which the aromatic compound is prepared, reacted with a reagent of formula (I) or (II) constituted of a diene backbone and bearing a phosphonate or phosphinate group on one of the double bonds, in the presence of a Lewis acid.

### FIELD OF THE INVENTION

The invention relates to new aromatic compounds bearing at least a phosphonate or phosphinate group on the aromatic ring.

The invention also relates to a process for their preparation.

### BACKGROUND OF THE INVENTION

Some molecules, oligomers or polymers containing both aromatic rings and phosphonic or phosphinic moities are of particular interest for various applications. The presence of these groups can confer some unique properties such as surface modification, flame retardancy, corrosion protection or ion exchange. Such molecules or materials could present some interest in application such as OPV (Organo PhotoVoltaic), fuel cells with proton exchange resins or intrinsic flame retardancy.

The problem is that typically the molecules or materials bearing both an aromatic ring and a phosphonate or phosphinate functionality can be prepared by phosphonation reaction involving aggressive reagents such as PCl₃. These reagents can alter the integrity of the material and are typically difficult to scale up. Alternatively, phosphites can be used to phosphonate aromatic ring but it involves a multi-step reaction route that is not practical or cost effective. Phosphonation using trialkylphosphites can be carried out under UV conditions [Bull. Chem. Soc. Jpn., 63, 938-940, (1990)]. However, the reaction is not selective and generates mixtures.

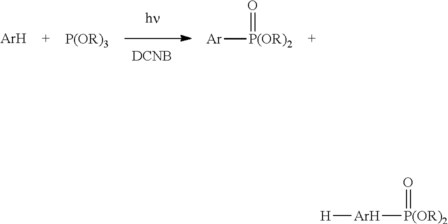

Alternatively, dialkylphosphites can be used to phosphonate rings even within a polymer matrix. The reaction is a 3 step process that involves a bromation, a phosphonation reaction and finally a deprotection reaction of the phosphonate [Macromol. Chem. Phys. (2003), 204, 61-67].

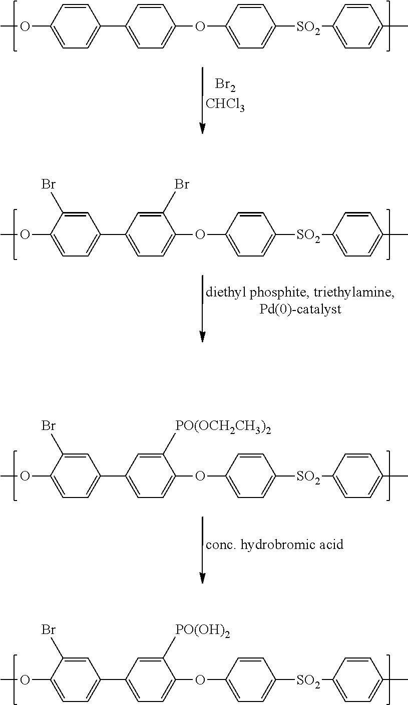

Alternatively, PCl₃ can be used to create P—C bond onto an aromatic ring with a catalytic amount of Lewis acid (U.S. Pat. No. 5,698,736) but it requires elevated temperatures. The aryl dichlorophosphine thus formed is very sensitive and must be hydrolysed to obtain the phosphonic acid functions.

### SUMMARY OF INVENTION

The objective of the present invention is to provide a process which makes it possible to overcome the above mentioned disadvantages.

A subject of the invention is a process for preparing aromatic compounds bearing at least a phosphonate or phosphinate group on the aromatic ring.

Another subject of the invention is the new obtained aromatic compounds.

There has now been found, and it is this which constitutes the subject matter of the present invention, a process for the preparation of a aromatic compound bearing a phosphonate or phosphinate group on the aromatic ring from an aromatic compound, characterized in that an aromatic compound with the formula (III):

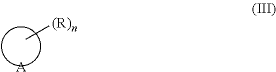

wherein:
A represents the residue of a cycle forming all or a portion of a monocyclic or polycyclic, aromatic, carbocyclic and/or heterocyclic system;
R, which may be identical or different, represents substituents on the cycle;
n represents the number of substituents on the cycle,
   is reacted with a reagent of formula (I) or (II) constituted of a diene backbone and bearing a phosphonate or phosphinate group on one of the double bonds, in the presence of a Lewis acid:

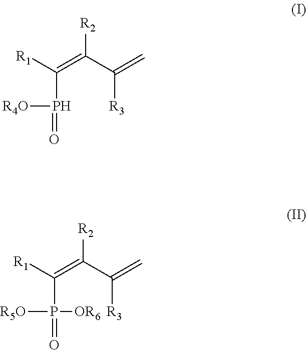

wherein:
R₁ and R₂, represent, independently, hydrogen, alkyl, alkenyl, aryl, alkaryl, aralkyl, cycloalkyl, heterocycloalkyl, or alkenyl groups,
R₃ represents an alkyl group or an electron-donating group,
R₄, R₅ and R₆ represent independently hydrogen, alkyl, aralkyle, cycloalkyle or metals selected from the group consisting of alkali metal or alkaline earth metal.

The present invention aims to provide new aromatic compounds bearing at least a phosphonate or phosphinate group with the formula (IV):

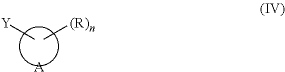

A represents the residue of a cycle forming all or a portion of a monocyclic or polycyclic, aromatic, carbocyclic and/or heterocyclic system;
R, which may be identical or different, represents substituents on the cycle;
n represents the number of substituents on the cycle,
Y represents one of the following groups (V) or (VI):

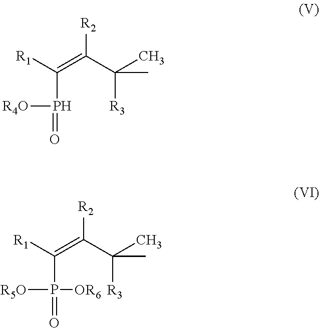

wherein:

R₁, R₂, R₃, R₄, R₅ and R₆ have the meanings given above.

### DETAILED DESCRIPTION OF INVENTION

### Phosphonate or Phosphorite Reagent

In the context of the invention, “alkyl” is understood to mean a linear or branched hydrocarbon chain having from 1 to 24 carbon atoms and preferably from 1 or 2 to 10 carbon atoms.

“Alkenyl” is understood to mean a linear or branched hydrocarbon group having from 1 to 24 carbon atoms and preferably from 2 to 15 carbon atoms and comprising one or more double bonds, preferably 1 to 2 double bonds.

“Cycloalkyl” is understood to mean a cyclic hydrocarbon group comprising from 3 to 8 carbon atoms, preferably a cyclopentyl or cyclohexyl group.

“Aryl” is understood to mean an aromatic mono- or polycyclic group, preferably a mono- or bicyclic group, comprising from 6 to 24 carbon atoms, preferably 6 to 12 carbon atoms, and more preferably phenyl or naphthyl.

“Arylalkyl” is understood to mean a linear or branched hydrocarbon group carrying an aromatic monocyclic ring and comprising from 7 to 24 carbon atoms, preferably 7 to 12 carbon atoms, and more preferably phenyl or naphthyl, and more preferably benzyl.

“Heterocycloalkyl” is understood to mean a cycloalkyle in which one or two carbon atoms are replaced by heteroatom such as oxygen, nitrogen, sulfur, comprising from 3 to 24 atoms and preferably from 3 to 18 atoms and more preferably 5 or 6 atoms.

The reagents which are particularly well suited to the implementation of the invention correspond to the formula (I) or (II) in which R₁ and R₂ represent hydrogen or methyl.

More preferably, R₁ represents methyl and R₂ represents hydrogen.

In formulae (I) or (II), R₃ represents a linear or branched alkyl group having from 1 to 6 carbon atoms, preferably methyl, ethyl, n-propyl, isopropyl group or an electron-donating group which is more particularly:
an alkoxy group containing 1 to 6 carbon atoms, more preferably 1 to 4 carbon atoms in the alkyl portion, or a phenoxy group;
a hydroxy group;
an amino group or an amino group preferably di-substituted in which the substituents, which may be identical or different, are linear or branched alkyl radicals containing 1 to 6 carbon atoms, more preferably 1 to 4 carbon atoms,
an alkylamide or arylamide group in which the alkyl group contains 1 to 6 carbon atoms, preferably 1 to 4 carbon atoms.

R₃ is not limited to the electron-donating groups mentioned above which constitute examples only.

Preferred compounds have formula (I) or (II) in which R₃ represents a C₁-C₃ alkyl group, a methoxy or ethoxy group, an amino group, a dimethyl or diethylamino group.

R₃ is more preferably a methyl group.

As regards the definition of the other symbols R₄, R₅ and R₆ involved in the formula (I) or (II), they represent a linear or branched alkyl group having from 1 to 6 carbon atoms, preferably methyl or ethyl group or metals selected from the group consisting of alkali metal or alkaline earth metal.

Among alkali metals, sodium or potassium is preferred.

Among alkaline earth metals, calcium is preferred.

Mention may be made, as preferred examples of reagents of formula (I) or (II) capable of being employed in the process of the invention, inter alia, of:

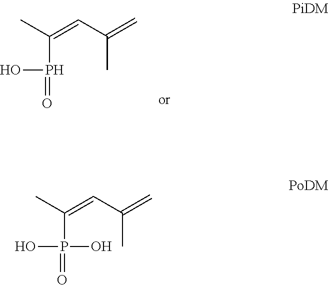

The phosphonate or phosphinate reagent of formula (I) or (II) and the process for their preparation are disclosed in PCT/CN2009/074726 and PCT/CN2009/07473 O.

### Aromatic Compound

The aromatic compound involved in the process of the invention corresponds to formula (III).

In the remainder of the description, the term “aromatic” denotes the conventional concept of aromaticity as defined in the literature, in particular by Jerry MARCH, “Advanced Organic Chemistry”, 4th edition, John Wiley & Sons, 1992, pp 40 ff.

The invention is of particular application to aromatic compounds with formula (III) in which A is the residue of a cyclic compound, preferably containing at least 4 carbon atoms in its cycle, preferably 5 or 6, optionally substituted, and representing at least one of the following cycles: a monocyclic or polycyclic aromatic carbocycle, i.e., a compound constituted by at least 2 aromatic carbocycles and between them forming ortho- or ortho- and peri-condensed systems, or a compound constituted by at least 2 carbocycles only one of which is aromatic and between them forming ortho- or ortho- and peri-condensed systems;
a monocyclic aromatic heterocycle containing at least one of heteroatoms P, O, N or S or a polycyclic aromatic heterocycle, i.e., a compound constituted by at least 2 heterocycles containing at least one heteroatom in each cycle wherein at least one of the two cycles is aromatic and between them forming ortho- or ortho- and peri-condensed systems, or a compound constituted by at least one carbocycle and at least one heterocycle at least one of the cycles being aromatic and forming ortho- or ortho- and peri-condensed systems between them.

The aromatic compound with formula (III) preferably carries at least one electron-donating group when this compound corresponds to formula (III) in which A represents a monocyclic or polycyclic aromatic carbocycle.

More particularly, optionally substituted residue A preferably represents the residue of an aromatic carbocycle such as benzene, an aromatic bicycle containing two aromatic carbocycles such as naphthalene; or a partially aromatic bicycle containing two carbocycles one of which is aromatic, such as tetrahydro-1,2,3,4-naphthalene.

The invention also envisages the fact that A can represent the residue of an aromatic heterocycle such as furan, pyridine or thiophene; an aromatic bicycle comprising an aromatic carbocycle and an aromatic heterocycle such as benzofuran or benzopyridine; a partially aromatic bicycle comprising an aromatic carbocycle and a heterocycle such as methylenedioxybenzene; an aromatic bicycle comprising two aromatic heterocycles such as 1,8-naphthylpyridine; a partially aromatic bicycle comprising a carbocycle and an aromatic heterocycle such as 5,6,7,8-tetrahydroquinoline.

In the process of the invention, an aromatic compound with formula (III) is preferably used in which A represents an aromatic nucleus, preferably a benzene or naphthalene nucleus.

The invention does not exclude the presence of a concatenation of the aromatic groups as defined above bonded together by a valence bond and/or by one of the following groups of the aromatic cycle into by a valence bond or by an alkylene group C1-C6 or by one of the following groups: —O—, —CO—, —COO—, —COO—.

The aromatic compound with formula (III) may carry no substituent particularly when the compound comprises a heterocycle with at least one atom carrying a free electron pair, preferably a nitrogen, oxygen, sulphur.

The aromatic compound with formula (III) preferably carries at least one electron-donating group when this compound only comprises one or several carbocycles.

The aromatic compound with formula (III) may carry one or several substituents

In the present text, the term “several” generally means less than 4 substituents R on the aromatic nucleus. n is preferably 1 or 2.

When there are other substituents than an electron-donating group, the nature of the other substituents is unimportant provided that it does not interfere with the principal reaction.

The aromatic compound with formula (III) carries more preferably an electron-donating group.

In the present text, the term “electron-donating group” means a group as defined by H. C. BROWN in the work by Jerry MARCH, “Advanced Organic Chemistry”, 4th edition, John Wiley & Sons, 1992, Chapter 9, pp. 273-292.

Starting compounds with formula (III) include those with formula (III) where R represents one of the following groups:
an alkoxy group containing 1 to 6 carbon atoms, more preferably 1 to 4 carbon atoms in the alkyl portion, or a phenoxy group;
a hydroxy group;
an amino group or an amino group preferably di-substituted in which the substituents, which may be identical or different, are linear or branched alkyl radicals containing 1 to 6 carbon atoms, more preferably 1 to 4 carbon atoms,
an alkylamide or arylamide group in which the alkyl group contains 1 to 6 carbon atoms, preferably 1 to 4 carbon atoms.

Preferred compounds have formula (III) in which R represents a methoxy or an ethoxy group.

R is not limited to the electron-donating groups mentioned above which constitute examples only.

### Friedel Crafts Type Catalyst

The catalyst used in the process of the invention is a Friedel-Crafts type catalyst.

A first class of catalysts suitable for the invention is constituted by Lewis acids.

Examples of organic salts which can be cited are the acetate, propionate, trifluoroacetate, benzoate, methanesulphonate and trifluoromethanesulphonate of metallic elements or metalloids from groups (IIIa), (IVa), (VIII), (IIb), (IIIb), (IVb), (Vb) and (VIb) of the periodic table.

Regarding inorganic salts, the chloride, bromide, iodide, sulphate, oxide and analogous products of metallic elements or metalloids from groups (IVa), (VIII), (IIb), (IIIb), (IVb), (Vb) and VIb) of the periodic table can be used.

In the present text, reference shall be made to the periodic table published in the Bulletin de la Société Chimique de France, no 1 (1966).

The salts used in the process of the invention are more particularly those from elements from group (IIa) of the periodic table, preferably scandium, yttrium and the lanthanides; from group (IVa), preferably titanium, zirconium; from group (VIII), preferably iron; from group (IIb), preferably zinc; from group (IIIb), preferably boron, aluminium, gallium, indium; from group (IVb), preferably tin; from group (Vb), preferably bismuth; from group (VIb), preferably tellurium.

Of the inorganic salts, metallic halides can be cited, preferably zirconium chloride, ferric chloride, zinc chloride, aluminium chloride, aluminium bromide, gallium chloride, indium chloride, stannic chloride, bismuth chloride, boron trifluoride; ferrous oxide, ferric oxide, and gallium oxide.

The present invention includes the case where the halide can be generated in situ using a known method.

Preferred examples of catalysts which can be cited are aluminium chloride and zinc chloride.

Regarding organic salts, rare earth and/or bismuth salts of trifluoromethanesulphonic acid (commonly known as triflic acid) are preferably used.

The term “rare earth” means lanthanides with an atomic number or 57 to 71, also yttrium and scandium.

The process of the invention more particularly envisages using the following rare earths: lanthanum, ytterbium, lutetium and/or scandium.

Rare earth triflates are known products. They are generally obtained by reacting a rare earth oxide with trifluoromethanesulphonic acid.

Bismuth salts of triflic acid can also be used in the process of the invention.

A further class of catalysts which is suitable for the invention is constituted by Brönsted acids, in particular sulphuric acid, hydrofluoric acid, hydrochloric acid, phosphoric acids and polyphosphoric acids, sulphonic acids and in particular trifluoromethanesulphonic acid, perfluorosulphonic acid and fluorosulphonic acid.

Preferred example of catalysts is sulphuric acid.

In the process of the invention, a solid catalyst as defined above is used which may also be supported. To this end, the support can be selected from metal oxides such as aluminium oxides, silicon and/or zirconium oxides, clays, more particularly kaolin, talc or montmorillonite, or from charcoal, possibly activated by a known treatment with nitric acid, acetylene black or resins.

The support can be in any form, for example a powder, beads, granules, extrudates . . . .

In the catalyst, the amount of active phase represents 5% to 100% of the weight of the catalyst.

In accordance with the process of the invention, the reaction between the aromatic compound and the phosphonate or phosphinate reagent is carried out in the liquid phase, in the presence or absence of an organic solvent; one of the reactants can be used as the reaction solvent.

In a preferred variation of the process of the invention, the reaction is carried out in an organic solvent.

A number of factors govern the choice of solvent.

It must be inert under the conditions of the invention, and must have a boiling point which is higher than the reaction temperature.

Preferably, an aprotic, low polarity organic solvent is used.

Examples of solvents which are suitable for the present invention which can in particular be cited are aliphatic or aromatic hydrocarbons, which may or may not be halogenated.

Examples of aliphatic hydrocarbons which can in particular be cited are paraffins such as hexane, heptane or cyclohexane and aromatic hydrocarbons, in particular aromatic hydrocarbons such as benzene, toluene, xylenes, cumene, and petroleum cuts constituted by a mixture of alkylbenzenes.

Regarding aliphatic or aromatic halogenated hydrocarbons, the following can in particular be cited: perchlorinated hydrocarbons such as tetrachloromethane; partially chlorinated hydrocarbons such as dichloromethane, chloroform, 1,2-dichloroethane and trichloroethylene; and halogenated aromatic hydrocarbons such as monochlorobenzene, dichlorobenzenes and mixtures thereof.

It is also possible to use mixture of organic solvents.

The present reaction is carried out using the reactants in the proportions mentioned below.

The ratio between the number of moles of aromatic compound and the number of moles of phosphonate or phosphinate reagent can vary as the substrate may act as the reaction solvent. Thus, the ratio can be from 0.1 to 10, preferably from 1 to 2.

The quantity of catalyst used is determined such that the ratio between the number of moles of catalyst and the number of moles of phosphonate or phosphinate reagent is preferably in the range 0.001 to 1.0, more preferably in the range 0.02 to 0.2.

Regarding the quantity of organic solvent used, it is generally selected such that the ratio between the number of moles of organic solvent and the number of moles of aromatic compound is preferably in the range 0 to 100, more preferably in the range 10 to 20.

The temperature at which the reaction is carried out depends on the reactivity of the starting substrate.

It is in the range 60° C. to 120° C., preferably in the range 80° C. to 100° C.

In general, the reaction is carried out at atmospheric pressure and the mixture is heated under reflux of reactants or of the solvent.

From a practical viewpoint, there are no restrictions on how the reactants are processed. They can be introduced in any order.

After bringing the reactants into contact, the reaction mixture is brought to the desired temperature.

A further variation of the invention consists of heating one of the reactants (phosphonate or phosphinate reagent or aromatic compound) with the catalyst then introducing the other reactant.

The reaction duration depends on a number of parameters. It is usually 30 minutes to 8 hours.

At the end of the reaction, the aromatic compound bearing at least a phosphonate or phosphinate function is recovered from the organic phase using known techniques, by eliminating the organic solvent by distillation or by crystallisation.

Under acidic conditions the diene function can favor the formation of a carbocation. Such property allows these molecules to be reactive towards aromatic rings under Friedel & Crafts reaction conditions. The overall reaction can create a carbon-carbon bond while the new molecule formed contains a phosphonic or phosphinic functionality. Such method is a very simple and straightforward way to introduce such functionalities onto aromatic rings under mild conditions. Indeed, the reaction can proceed smoothly with catalytic amount of simple acids such as sulfuric acid.

### Applications

These phosphonating or phosphinating reagents of formula (I) or (II) can be used to prepare new aromatic molecules bearing phosphonic or phosphinic groups that could possess some flame retardant properties.

The same molecules could also be used for surface modification of metallic or glass surface to adjust their wettability and/or improve their paintability. Because of the presence of the aromatic group, these new obtained phosphonate or phosphonate products could find some applications to improve the wettability of electrodes in organic polymers for OPV systems or electronic organic applications.

Thus, another application of the present invention is to introduce a phosphonate or phosphinate group on an aromatic ring which is included into a is polymer.

Indeed, the conditions for introducing the said groups being mild, it is possible to graft the said groups within the final polymer

An example is to prepare proton conducting membranes bearing a phosphonate or phosphinate group.

### EXAMPLES

The following examples, given without implied limitation, illustrate the present invention.

### Example 1

### Preparation of Phosphonated Dimethoxybenzene

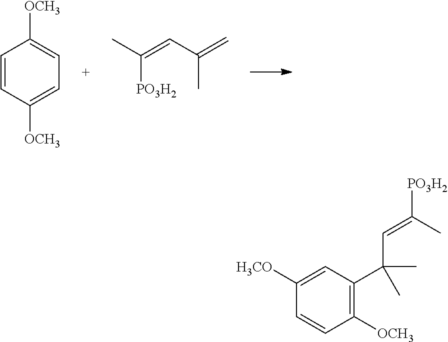

2.1 g (0.015 mol) of 1,4-dimethoxybenzene and 3.4 g (80%, 0.0165 mol) of PoDM are added to 2 ml heptane in a 100 ml reactor.

0.16 ml H₂SO₄ (98 wt. %) are then added dropwise in 20 min at room temperature and the mixture is heated at 120° C.

The mixture is allowed to react for 3 h reaction and is then cooled down to room temperature.

A 6 M aqueous soda solution is added dropwise until pH=7.

The organic layer (lower layer) is separated and the pH is adjusted at 4 with an aqueous sulphuric acid solution (30 wt. %)

The obtained product precipitates.

3.4 g of that product is recovered by filtration.

The yield is 57%.

The obtained product is analysed by ¹H NMR and ³¹P NMR:

¹H NMR (300 MHz, CDCl₃, TMS): δ 1.35 (d, J=18.0, 3H), 1.44 (s, 6H), 3.66 ((s, 3H), 3.79 (s, 3H), 6.69-6.91 (m, 4H); ¹³C NMR (75 MHz, CDCl₃, TMS): δ 11.97, 12.11, 28.34, 38.97, 39.25, 55.64, 56.22, 110.46, 113.12, 113.18, 138.23, 151.80, 153.59, 154.40, 154.50;

³¹P NMR (112 MHz, CDCl₃, TMS): δ 25.46. MS (EI) m/z 300 (M⁺), 268, 219, 203, 187.

### Example 2

### Preparation of Phosphonated Thiophene

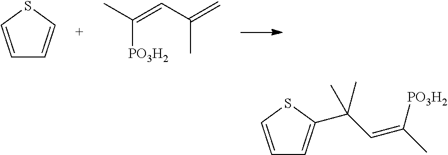

2.81 g (95%, 16.5 mmol) of PoDM and 2.77 g (33 mmol) of thiophene are charged into a 50 mL three-necked flask which is equipped with a thermometer, a condenser and a magnetic stirrer.

0.083 g (98%, 0.825 mmol) H₂SO₄ are then added by dropwise in 5 min at room temperature under nitrogen and then the mixture is heated to reflux for 24 h.

The medium reaction is cooled down to room temperature, diluted with 50 mL of water and is then is extracted with ethyl acetate (30 mL×3).

The organic layer is separated and concentrated to give 1.22 g of a dark red oil.

The obtained yield is 30%.

The obtained product is analysed by ¹H NMR and ³¹P NMR:

¹H NMR (300 MHz, DMSO, TMS): δ 1.46 (s, 6H), 1.88 (s, 3H), 6.85 (d, 1H), 6.90 (t, 1H), 7.30 (d, 1H); ³¹P NMR (112 MHz, DMSO, TMS): δ 15.98.

### Example 3

### Preparation of Phosphonated Thiophene

5.62 g (95%, 33 mmol) of PoDM and 5.54 g (66 mmol) of thiophene are charged into a 50 mL three-necked flask which is equipped with a thermometer, a condenser and a magnetic stirrer.

0.54 g (3.3 mmol) of FeCl₃ is added at room temperature under nitrogen and the mixture is then heated to reflux for 24 h.

The medium reaction is cooled down to room temperature, diluted with 100 mL of water and is then is extracted with ethyl acetate (60 mL×3).

The organic layer is separated and concentrated to give 1.63 g of a dark red oil.

The obtained yield is 20%.

The ¹H NMR analysis of the obtained product is the same with example 2.

1. A process for the preparation of an aromatic compound, the process comprising reacting an aromatic compound with the formula (III): 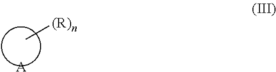
wherein:
A represents the residue of a cycle forming all or a portion of a monocyclic or polycyclic, aromatic, carbocyclic and/or heterocyclic system;
R, which may be identical or different, represents substituents on the cycle; and
n represents the number of substituents on the cycle,
with a reagent of formula (I) or (II) constituted of a diene backbone and bearing a phosphonate or phosphinate group on one of the double bonds, in the presence of a Lewis acid: 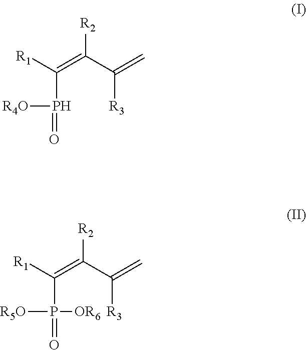
wherein:
R₁ and R₂, represent, independently, hydrogen, alkyl, alkenyl, aryl, alkaryl, aralkyl, cycloalkyl, heterocycloalkyl, or alkenyl groups,
R₃ represents an alkyl group or an electron-donating group, and
R₄, R₅ and R₆ represent independently hydrogen, alkyl, aralkyl, cycloalkyl or metals selected from the group consisting of alkali metal or alkaline earth metal, wherein the resulting aromatic compound bears a phosphonate or phosphinate group on the aromatic ring.

2. The process as claimed in claim 1, wherein the reagent corresponds to the formula (I) or (II) in which R₁ and R₂ represent hydrogen or methyl.

3. The process as claimed in claim 1, wherein the reagent corresponds to the formula (I) or (II) in which R₃ represents a linear or branched alkyl group having from 1 to 6 carbon atoms or an electron-donating group.

4. The process as claimed in claim 3,
wherein the reagent corresponds to the formula (I) or (II) in which R₃ represents (I) or (II) in which R₃ represents a C₁-C₃ alkyl group, a methoxy or ethoxy group, an amino group, a dimethyl or diethylamino group.

5. The process as claimed in claim 1, wherein the reagent corresponds to the formula (I) or (II) in which R₄, R₅ and R₆ represent a linear or branched alkyl group having from 1 to 6 carbon atoms, or metals selected from the group consisting of alkali metal or alkaline earth metal.

6. The process as claimed in claim 1, wherein the reagent corresponding to the formula (I) or (II) is:

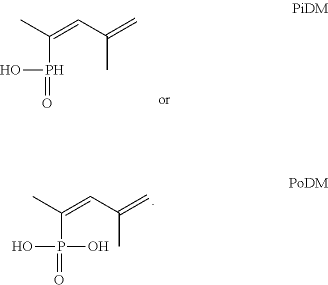

7. The process as claimed in claim 1, wherein the aromatic compound corresponds to formula (III) in which A is the residue of a cyclic compound.

8. The process as claimed in claim 1, wherein the aromatic compound corresponding to formula (III) carries at least one electron-donating group on the aromatic ring.

9. The process as claimed in claim 1, wherein the aromatic compound corresponds to formula (III) in which A represents an aromatic nucleus.

10. The process as claimed in claim 7, wherein the aromatic compound corresponds to formula (III) in which A represents the residue of furan, pyridine or thiophene; benzofuran or benzopyridine methylenedioxybenzene; 1,8-naphthylpyridine; 5,6,7,8-tetrahydroquinoline.

11. The process as claimed in claim 1, wherein the aromatic compound corresponds to formula (III) in which n is 1 or 2.

12. The process as claimed in claim 1, wherein the aromatic compound corresponds to formula (III) in which R represents one of the following groups:
an alkoxy group containing 1 to 6 carbon atoms,
a hydroxy group;
an amino group or an amino group optionally di-substituted in which the substituents, which may be identical or different, are linear or branched alkyl radicals containing 1 to 6 carbon atoms; and
an alkylamide or arylamide group in which the alkyl group contains 1 to 6 carbon atoms.

13. The process as claimed in claim 1, wherein a Friedel-Crafts type catalyst is selected from the group consisting of: acetate, propionate, trifluoroacetate, benzoate, methanesulphonate and trifluoromethanesulphonate of metallic elements or metalloids from groups (IIIa), (IVa), (VIII), (IIb), (IIIb), (IVb), (Vb) and (VIb) of the periodic table.

14. The process as claimed in claim 1, wherein a Friedel-Crafts catalyst is selected from the group consisting of: chloride, bromide, iodide, sulphate, oxide and analogous products of metallic elements or metalloids from groups (IVa), (VIII), (IIb), (IIIb), (IVb), (Vb) and (VIb) of the periodic table.

15. The process as claimed in claim 13, wherein a Friedel-Crafts type catalyst is selected from the group consisting of: aluminium chloride, zinc chloride, triflate lanthanum.

16. The process as claimed in claim 1, wherein a Friedel-Crafts catalyst is selected from the group consisting of: sulphuric acid, hydrofluoric acid, hydrochloric acid, phosphoric acids and polyphosphoric acids, and sulphonic acids.

17. An aromatic compound bearing at least a phosphonate or phosphinate group with the formula (IV): 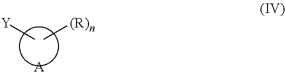
A represents the residue of a cycle forming all or a portion of a monocyclic or polycyclic, aromatic, carbocyclic and/or heterocyclic system;
R, which may be identical or different, represents substituents on the cycle;
n represents the number of substituents on the cycle, and
Y represents one of the following groups (V) or (VI): 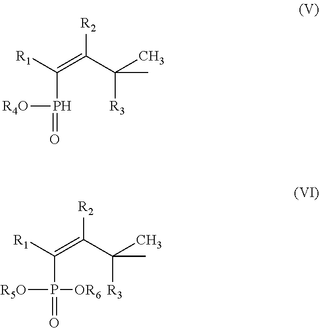
wherein:
R₁, R₂, R₃, R₄, R₅ and R₆ represent hydrogen, alkyl, alkenyl, aryl, alkaryl, aralkyl, cycloalkyl, heterocycloalkyl, or alkenyl groups, alkyl group or an electron-donating group, or metals selected from the group consisting of alkali metal or alkaline earth metal as claimed in claim 1.

18. The process as claimed in claim 1, wherein the process comprises introducing a phosphonate or phosphinate group on an aromatic ring included in a polymer.

19. The process as claimed in claim 3, wherein R₃ in formula (I) or (II) is selected from the group consisting of methyl, ethyl, n-propyl, and isopropyl.

20. The process as claimed in group 3, wherein the electron-donating group is selected from the group consisting of an alkoxy group containing 1 to 6 carbon atoms, a hydroxy group, an amino group and an alkylamide or arylamide group

21. The process as claimed in claim 3, wherein the alkoxy group has 1 to 4 carbon atoms in the alkyl portion, or a phenoxy group.

22. The process as claimed in claim 3, wherein the amino group is di-substituted and the substituents, which may be identical or different, are linear or branched alkyl radicals having 1 to 6 carbon atoms.

23. The process as claimed in claim 22, wherein the linear or branched alkyl radicals have 1 to 4 carbon atoms.

24. The process as claimed in claim 3, wherein the alkylamide or arylamide have an alkyl group having 1 to 6 carbon atoms.

25. The process as claimed in claim 23, wherein the alkyl group has 1 to 4 carbon atoms.

26. The process as claimed in claim 5, wherein R₆ is a methyl or ethyl group.

27. The process as claimed in claim 7, wherein A in formula (III) is a residue of a cyclic compound having at least 4 carbon atoms in its cycle.

28. The process as claimed in claim 7, wherein A in formula (III) has 5 or 6 carbon atoms in its cycle, is optionally substituted, and represents at least one of the following cycles:
a monocyclic or polycyclic aromatic carbocycle, i.e., a compound constituted by at least 2 aromatic carbocycles and between them forming ortho- or ortho- and pen-condensed systems, or a compound constituted by at least 2 carbocycles only one of which is aromatic and between them forming ortho- or ortho- and peri-condensed systems; and
a monocyclic aromatic heterocycle containing at least one of heteroatoms P, O, N or S or a polycyclic aromatic heterocycle, i.e., a compound constituted by at least 2 heterocycles containing at least one heteroatom in each cycle wherein at least one of the two cycles is aromatic and between them forming ortho- or ortho- and peri-condensed systems, or a compound constituted by at least one carbocycle and at least one heterocycle at least one of the cycles being aromatic and forming ortho- or ortho- and peri-condensed systems between them.

29. The process as claimed in claim 9, wherein the aromatic nucleus is a benzene nucleus or a naphthalene nucleus.

30. The process as claimed in claim 16, wherein the sulphonic acid is trifluoromethanesulphonic acid, perfluorosulphonic acid or fluorosulphonic acid.
